(19) United States
(12) Patent Application Publication
(10) Pub. No.: US 2017/0320072 A1
(43) Pub. Date: Nov. 9, 2017

(54) MULTI TOUCH CONTROL TYPE WATER OUTPUT SWITCHING SHOWER DEVICE

(71) Applicant: Xiamen Runner Industrial Corporation, Xiamen (CN)

(72) Inventors: SHUN-CHUAN ZHENG, Xiamen (CN); CHUN-HUI LIN, Xiamen (CN); WEN GAO, Xiamen (CN)

(21) Appl. No.: 15/416,063

(22) Filed: Jan. 26, 2017

(30) Foreign Application Priority Data
May 6, 2016 (CN) 201610295275.1

(51) Int. Cl. B05B 1/16; B05B 12/00; B05B 1/18

(52) U.S. Cl. CPC B05B 1/1636; B05B 1/18; B05B 12/002

(57) ABSTRACT

A multi touch control type water output switching shower device, comprising: a shower main body; an electrical switching mechanism, disposed in an inner chamber of the shower main body, to switch between a plurality of water output channels; a control electrical circuit board, disposed in the chamber of the shower main body, and connected electrically to the electrical switching mechanism; a power supply unit, connected electrically to the control electrical circuit board, to supply power to the electrical switching mechanism; a water separating frame, disposed in the inner chamber of the shower main body through using bolts; a plurality of touch press keys, disposed on the control electrical circuit board, to control the electrical switching mechanism to perform various actions; and a plurality of touch areas, disposed on a surface of a shower device, corresponding to the respective touch press keys.

### FIELD OF THE INVENTION

The present invention relates to a shower device, and in particular to a multi touch control type water output switching shower device.

### THE PRIOR ARTS

Conventionally, a shower device utilizes mechanical push buttons, that make use of ball point pen or G wheel principle, to realize water output switching. In this approach, the push button and its surrounding portions are separate. In a pressing operation, the top surface of the push button can be pressed down to produce height difference, while a force of certain strength has to be applied to make the pressing operation work, otherwise, the water output switching can not be achieved.

Therefore, presently, the design and performance of the shower device water switching is not quite satisfactory, and it leaves much room for improvement.

### SUMMARY OF THE INVENTION

In view of the problems and drawbacks of the prior art, the present invention provides a multi touch control type water output switching shower device, that is novel in design, easy in operation, and pleasing in appearance, to overcome the shortcomings of the prior art.

The present invention provides a multi touch control type water output switching shower device, comprising: a shower main body, an electrical switching mechanism, a control electrical circuit board, a power supply unit, a water separating frame, a plurality of touch press keys, and a plurality of touch areas. The electrical switching mechanism is disposed in an inner chamber of the shower main body, to switch between a plurality of water output channels. The control electrical circuit board is disposed in the inner chamber of the shower main body, and is connected electrically to the electrical switching mechanism. The power supply unit is disposed in the inner chamber of the shower main body, and is connected electrically to the control electrical circuit board, to supply power to the electrical switching mechanism. The water separating frame is disposed in the inner chamber of the shower main body. The plurality of touch press keys are disposed on the control electrical circuit board, to control the electrical switching mechanism to perform various actions. The plurality of touch areas are disposed on a surface of a shower device, corresponding to the respective touch press keys.

In an aspect of the present invention, the electrical switching mechanism includes: a decelerating motor, disposed on the water separating frame; and a central axis, disposed on an output end of the decelerating motor, and in a switching chamber of the water separating frame.

In another aspect of the present invention, the water separating frame includes: a position restriction block, disposed in the switching chamber of the water separating frame, to support the central axis and restrict its axial movement; and a plurality of en-capsuled water seal plates, disposed in the respective water output holes of the switching chamber of the water separating frame, to act in tight seal cooperation with a blocking block on a side of the central axis.

In yet another aspect of the present invention, the multi touch control type water output switching shower device further includes: a decoration cover, disposed in a water output port in a head portion of the shower main body, such that the control electrical circuit board and the touch press keys are disposed inside the decoration cover, while the touch areas are disposed on an outer side of the decoration cover; a face cover, disposed and embedded inside the decoration cover, to act in cooperation with the water separating frame; a water separating connection piece, disposed between the face cover and the water separating frame; and an impeller, disposed inside the face cover, and is located in a water output channel.

In a further aspect of the present invention, the touch press key is a touch spring.

In another aspect of the present invention, the multi touch control type water output switching shower device further includes: a water passage head, connected between a handle water output hole of the shower main body, and a water input hole of the water separating frame; a first O ring, sleeved around a water input connector of the water passage head, and in tight seal cooperation with the handle water output hole; and a second O ring, sleeved around a water output connector of the water passage head, and in tight seal cooperation with the water input hole of the water separating frame.

In yet another aspect of the present invention, the power supply unit is a hydroelectric charging device, and it includes: a magnetic coil separation sleeve; an impeller having magnetic coil, disposed outside the magnetic coil separation sleeve, and is located in a water input channel of the shower main body; and a generator coil, disposed inside the magnetic coil separation sleeve, while the generator coil is connected electrically to a power electric circuit board, and the power electric circuit board is connected electrically to the power supply unit and the control electrical circuit board.

In a further aspect of the present invention, the multi touch control type water output switching shower device further includes: a tight seal cover, disposed over the water separating frame, used to cover the power electric circuit board, the power supply unit, and the decelerating motor; and a shaped rubber ring, disposed on a cooperation plane between the tight seal cover and the water separating frame.

In another aspect of the present invention, the power supply unit is an outside charging device, and it includes: a USB element, connected electrically to the control electrical circuit board, the USB element is exposed on a surface of the shower device, and is covered by a tight seal element; and a plurality of rechargeable batteries, connected electrically to the control electrical circuit board.

In yet another aspect of the present invention, the multi touch control type water output switching shower device further includes: a spring plate, disposed between the rechargeable batteries to connect them in series, while the rechargeable batteries are disposed on the water separating frame.

The present invention further provides a multi touch control shower water output switching method utilizing the multi touch control type water output switching shower device, comprising the following steps: activating one touch press key through touching on one touch area on the surface of the shower device, such that control electrical circuit board is activated to control and put the electrical switching mechanism into action, to switch open one water output channel to output water; and activating one other touch press key through touching on one other touch area on the surface of the shower device, such that control electrical circuit board is activated to control and put the electrical switching mechanism into action, to switch open one other water output channel to output water, as such achieving multi touch control shower water output switching.

Compared with the existing technology, the present invention has the following advantages: the multi touch control type water output switching shower device makes use of the multi touch control press keys to control the electrical switching mechanism to perform various functions. Since the touch control press keys are embedded inside the shower device, they give a smooth and neat outer appearance. In addition, in applying the touch control functions, all it needs is a light and gentle touch on the control press key, and there is no need to press hard with great effort to make it work. Further, it could avoid the problem of press key failure due to long period of usage.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a multi touch control type water output switching shower device according to the present invention;

FIG. 2 is a cross section view of a multi touch control type water output switching shower device along the A-A line of FIG. 1 according to the first embodiment of the present invention;

FIG. 3 is an exploded view of a multi touch control type water output switching shower device according to the first embodiment of the present invention;

FIG. 4 is a cross section view of a multi touch control type water output switching shower device along the A-A line of FIG. 1 according to the second embodiment of the present invention; and

FIG. 5 is an exploded view of a multi touch control type water output switching shower device according to the second embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

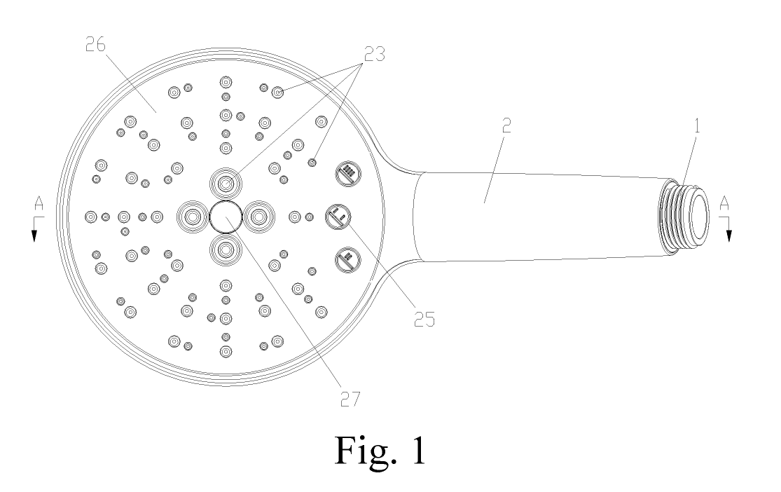

Refer to FIGS. 1 to 5 respectively for a schematic diagram of a multi touch control type water output switching shower device according to the present invention; a cross section view of a multi touch control type water output switching shower device along the A-A line of FIG. 1 according to the first embodiment of the present invention; an exploded view of a multi touch control type water output switching shower device according to the first embodiment of the present invention; a cross section view of a multi touch control type water output switching shower device along the A-A line of FIG. 1 according to the second embodiment of the present invention; and an exploded view of a multi touch control type water output switching shower device according to the second embodiment of the present invention.

As shown in FIGS. 1 to 5, the present invention provides a multi touch control type water output switching shower device, comprising: a shower main body 2, an electrical switching mechanism, a control electrical circuit board 24, a power supply unit 12, a water separating frame 15, a plurality of touch press keys 25, and a plurality of touch areas. The electrical switching mechanism is disposed in an inner chamber of the shower main body 2, to switch between a plurality of water output channels. The control electrical circuit board 24 is disposed in the inner chamber of the shower main body 2, and is connected electrically to the electrical switching mechanism. The power supply unit 12 is disposed in the inner chamber of the shower main body 2, and is connected electrically to the control electrical circuit board 24, to supply power to the electrical switching mechanism. The water separating frame 15 is disposed in the inner chamber of the shower main body 2. The plurality of touch press keys 25 are disposed on the control electrical circuit board 24, to control the electrical switching mechanism to perform various actions. The plurality of touch areas are disposed on a surface of a shower device, corresponding to the respective touch press keys 25. In other words, the various touch areas are parts of the surface of the shower device, that are formed integrally without any seams in between.

In application, the multi touch control type water output switching shower device is performed in the following ways: activating one touch press key 25 through touching on one touch area on the surface of the shower device, such that control electrical circuit board 24 is activated to control and put the electrical switching mechanism into action, to switch open one water output channel to output water; and activating one other touch press key 25 through touching on one other touch area on the surface of the shower device, such that control electrical circuit board 24 is activated to control and put the electrical switching mechanism into action, to switch open one other water output channel to output water, as such achieving multi touch control shower water output switching.

In the present invention, the electrical switching mechanism includes: a decelerating motor 14, disposed on the water separating frame 15; and a central axis 17, disposed on an output end of the decelerating motor 14, and in a switching chamber of the water separating frame 15.

Further, in the present invention, the water separating frame 15 includes: a position restriction block 19, disposed in the switching chamber of the water separating frame 15, to support the central axis and restrict its axial movement; a plurality of en-capsuled water seal plates 18, disposed in the respective water output holes of the switching chamber of the water separating frame 15, to act in tight seal cooperation with a blocking block on a side of the central axis 17; and a fifth O ring 16 is disposed at one end of the central axis 17 connecting to the decelerating motor 14, to act in tight seal cooperation with an installation hole on the water separating frame 15.

In the present invention, a threaded connector 1 is installed on a water input port in a handle of the shower main body 2. The multi touch control type water output switching shower device further includes: a decoration cover 26, disposed in a water output port in a head portion of the shower main body 2, such that the control electrical circuit board 24 and the touch press keys 25 are disposed inside the decoration cover 26, while the touch areas are disposed on an outer side of the decoration cover 26; a face cover 23, disposed and embedded inside the decoration cover 26, to act in cooperation with the water separating frame 15; a water separating connection piece 21, disposed between the face cover 23 and the water separating frame 5; and an impeller 22, disposed inside the face cover 23, and is located in a water output channel to output massage water. Namely, the various touch areas are parts of the surface of the shower device, that are formed integrally without any seams in between. In the structure mentioned above, the touch press key adopts a capacitive type touch control press key, such as a touch spring 25.

### Embodiment 1

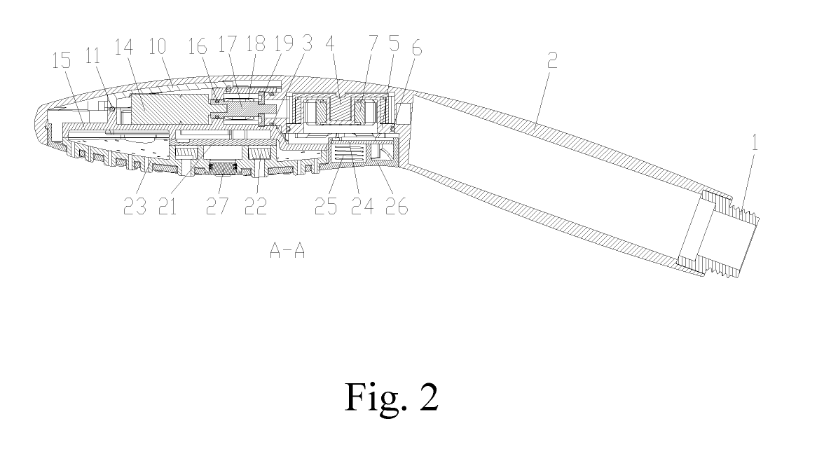

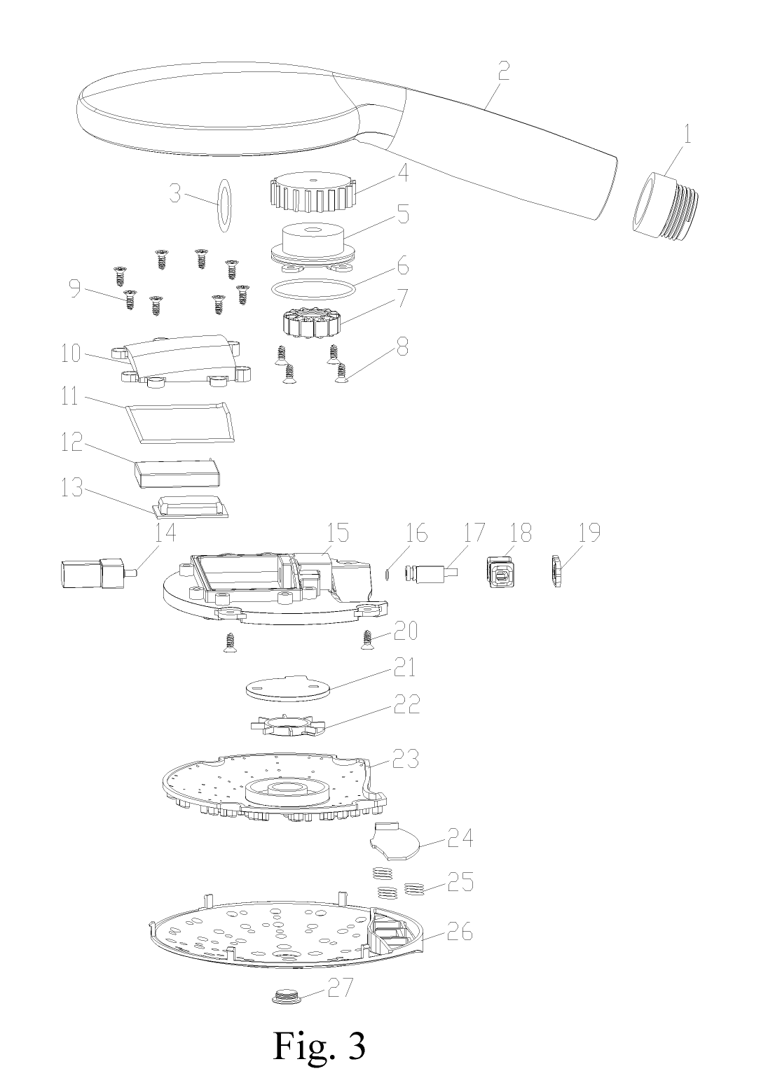

In the present embodiment, as shown in FIGS. 2 and 3, the power supply unit is a hydroelectric charging device, and it includes: a magnetic coil separation sleeve 5; an impeller having magnetic coil 4, disposed outside the magnetic coil separation sleeve 5, and is located in a water input channel of the shower main body 2; and a generator coil 7, disposed inside the magnetic coil separation sleeve 5, while the generator coil 7 is connected electrically to a power electric circuit board 13, and the power electric circuit board 13 is connected electrically to the power supply unit 12 and the control electrical circuit board 24.

The multi touch control type water output switching shower device further includes: a tight seal cover 10, disposed over the water separating frame 15, used to cover the power electric circuit board 13, the power supply unit 12, and the decelerating motor 14; and a shaped rubber ring 11, disposed on a cooperation plane between the tight seal cover 10 and the water separating frame 15, to avoid the power electric circuit board 13, the rechargeable battery 12, and the decelerating motor 14 being damaged by water leakage.

A hydroelectric generator seat is disposed in an inner chamber of a head portion of the shower main body 2, used for installing the hydroelectric charging device. The generator coil 7 is fixed onto the hydroelectric generator seat through using the bolts 8. A third O ring 6 is disposed on the magnetic coil separation sleeve 5, to act in tight seal cooperation with the inner chamber of the hydroelectric generator seat. The inner chamber of the hydroelectric generator seat is connected and in communication with the handle inner chamber of the shower main body 2 through a slant hole. A fourth O ring 3 is sleeved around a water output connector of the hydroelectric generator seat, to act in tight seal cooperation with the water input hole of the water separating frame 15.

In the present embodiment, the operation of the multi touch control type water output switching shower device can be carried out as follows: firstly, water flows in the handle inner chamber of the shower main body 2 through the threaded connector 1, then the water flows into the hydroelectric generator seat in the inner chamber of the head portion through a slant water hole at an end of the handle inner chamber. As the water flows through the hydroelectric generator seat, it brings the impeller having magnetic coil 4 into rotation, to generate electricity and stores it in the rechargeable battery 12 as a power source for the electric switching mechanism. Then, the water flows into the switching chamber of the water separating frame 15, through the water output hole of the hydroelectric generator seat.

When it is desired to switch to a certain showering mode, the user may activate one touch press key 25 through touching lightly on one touch area on the decoration cover 26, such that control electrical circuit board 24 is activated to control and put the electrical switching mechanism into action, to switch open one water output channel to output water. And when it is desired to switch to another showering mode, the user may activate one other touch press key 25 through touching lightly on one other touch area on the decoration cover 26, such that control electrical circuit board 24 is activated to control and put the electrical switching mechanism into action, to switch open one other water output channel to output water, as such achieving multi touch control shower water output switching.

### Embodiment 2

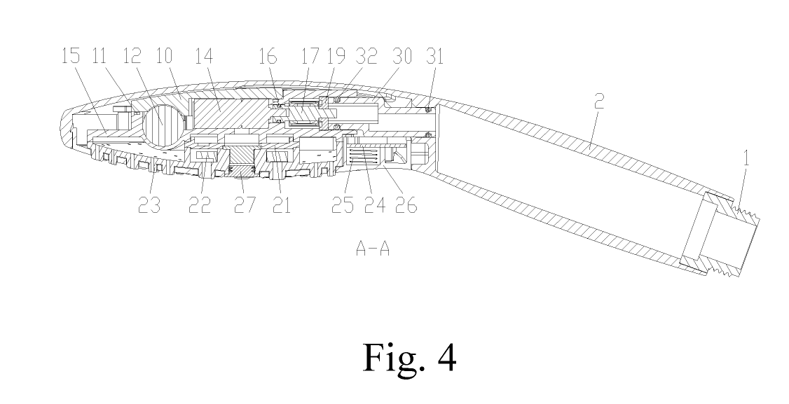

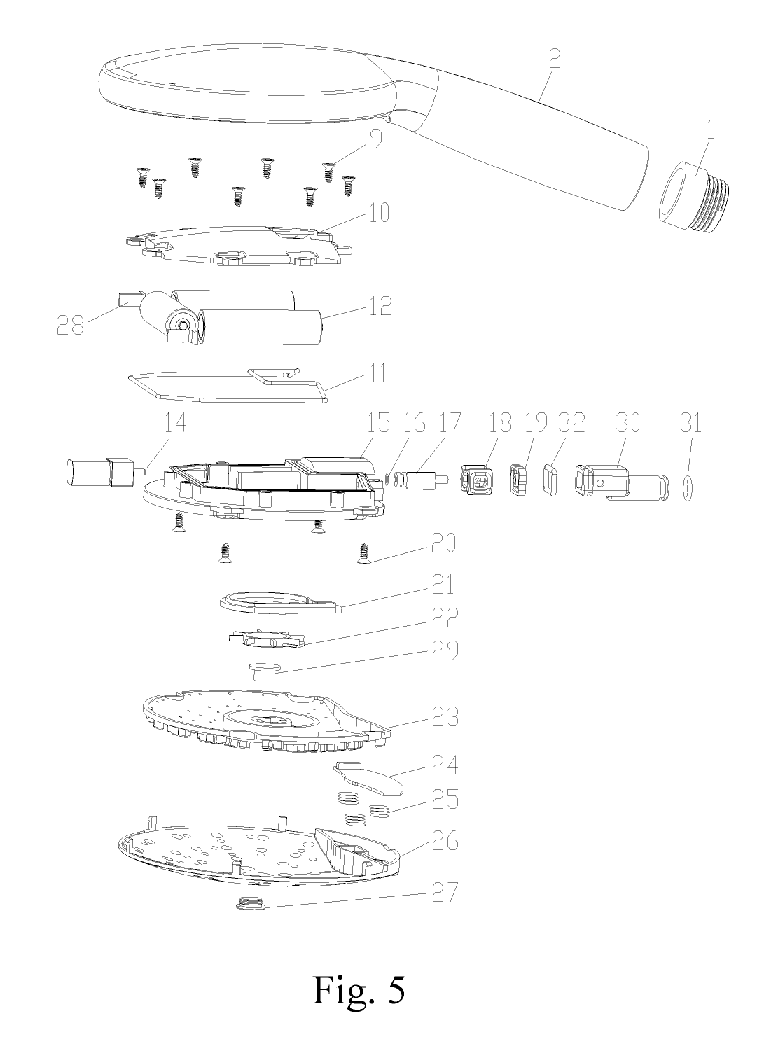

In the present embodiment, as shown in FIGS. 4 and 5, the power supply unit 12 is an outside charging device, and it includes: a USB element 29, connected electrically to the control electrical circuit board 24, the USB element 29 is exposed on a surface of the shower device, and is covered by a tight seal element 27; and a plurality of rechargeable batteries 12, connected electrically to the power electrical circuit board 13 and the control electrical circuit board 24. An insertion hole is provided in the center of the decoration cover 26 exposing the USB element 29, used for charging of device. The insertion hole is covered by the tight seal element 27, to give the shower device a pleasing appearance.

The multi touch control type water output switching shower device further includes: a water passage head 30, connected between a handle water output hole of the shower main body 2, and a water input hole of the water separating frame 15; a first O ring 31, sleeved around a water input connector of the water passage head 30, and in tight seal cooperation with the handle water output hole; and a second O ring 32, sleeved around a water output connector of the water passage head 30, and in tight seal cooperation with the water input hole of the water separating frame 15.

In the present embodiment, a spring plate 28 is disposed between the rechargeable batteries 12, to connect them in series, while the rechargeable batteries 12 are disposed on the water separating frame 15. A tight seal cover 10 is installed over the water separating frame 15 through using bolts 9, to cover the power electric circuit board 13, the rechargeable battery 12, and the decelerating motor 14. And a shaped rubber ring 11 is disposed on a cooperation plane between the tight seal cover 10 and the water separating frame 15, to avoid the rechargeable battery 12 and the decelerating motor 14 being damaged due to water leakage.

In the present embodiment, the operation of the multi touch control type water output switching shower device can be carried out as follows: firstly, water flows into the handle inner chamber of the shower main body 2 through the threaded connector 1, then the water flows through the water passage head 30, and then it flows into the switching chamber of the water separating frame 15 from the handle inner chamber.

When it is desired to switch to a certain showering mode, the user may activate one touch press key 25 through touching lightly on one touch area on the decoration cover 26, such that control electrical circuit board 24 is activated to control and put the electrical switching mechanism into action, to switch open one water output channel to output water. And when it is desired to switch to another showering mode, the user may activate one other touch press key 25 through touching lightly on one other touch area on the decoration cover 26, such that control electrical circuit board 24 is activated to control and put the electrical switching mechanism into action, to switch open one other water output channel to output water, as such achieving multi touch control shower water output switching.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A multi touch control type water output switching shower device, comprising:
a shower main body;
an electrical switching mechanism, disposed in an inner chamber of the shower main body, to switch between a plurality of water output channels;
a control electrical circuit board, disposed in the inner chamber of the shower main body, and connected electrically to the electrical switching mechanism;
a power supply unit, disposed in the inner chamber of the shower main body, and is connected electrically to the control electrical circuit board, to supply power to the electrical switching mechanism;
a water separating frame, disposed in the inner chamber of the shower main body through using bolts;
a plurality of touch press keys, disposed on the control electrical circuit board, to control the electrical switching mechanism to perform various actions; and
a plurality of touch areas, disposed on a surface of the shower device, corresponding to the respective touch press keys.

2. The multi touch control type water output switching shower device as claimed in claim 1, wherein the electrical switching mechanism includes:
a decelerating motor, disposed on the water separating frame; and
a central axis, disposed on an output end of the decelerating motor, and in a switching chamber of the water separating frame.

3. The multi touch control type water output switching shower device as claimed in claim 1, wherein the water separating frame includes:
a position restriction block, disposed in the switching chamber of the water separating frame, to support the central axis and restrict its axial movement; and
a plurality of encapsuled water seal plates, disposed in the respective water output holes of the switching chamber of the water separating frame, to act in tight seal cooperation with a blocking block on a side of the central axis.

4. The multi touch control type water output switching shower device as claimed in claim 1, further comprising:
a decoration cover, disposed in a water output port in a head portion of the shower main body, such that the control electrical circuit board and the touch press keys are disposed inside the decoration cover, while the touch areas are disposed on an outer side of the decoration cover;
a face cover, disposed and embedded inside the decoration cover, to act in cooperation with the water separating frame;
a water separating connection piece, disposed between the face cover and the water separating frame; and
an impeller, disposed inside the face cover, and is located in a water output channel.

5. The multi touch control type water output switching shower device as claimed in claim 1, wherein the touch press key is a touch spring.

6. The multi touch control type water output switching shower device as claimed in claim 1, further comprising:
a water passage head, connected between a handle water output hole of the shower main body, and a water input hole of the water separating frame;
a first O ring, sleeved around a water input connector of the water passage head, and in tight seal cooperation with the handle water output hole; and
a second O ring, sleeved around a water output connector of the water passage head, and in tight seal cooperation with the water input hole of the water separating frame.

7. The multi touch control type water output switching shower device as claimed in claim 1, wherein the power supply unit is a hydroelectric charging device, comprising:
a magnetic coil separation sleeve;
an impeller having magnetic coil, disposed outside the magnetic coil separation sleeve, and is located in a water input channel of the shower main body; and
a generator coil, disposed inside the magnetic coil separation sleeve, while the generator coil is connected electrically to a power electric circuit board, and the power electric circuit board is connected electrically to the power supply unit and the control electrical circuit board.

8. The multi touch control type water output switching shower device as claimed in claim 7, further comprising:
a tight seal cover, disposed over the water separating frame, used to cover the power electric circuit board, the power supply unit and the decelerating motor; and
a shaped rubber ring, disposed on a cooperation plane between the tight seal cover and the water separating frame.

9. The multi touch control type water output switching shower device as claimed in claim 1, wherein the power supply unit is an outside charging device, including:
a USB element, connected electrically to the control electrical circuit board, the USB element is exposed on a surface of the shower device, and is covered by a tight seal element; and
a plurality of rechargeable batteries, connected electrically to the control electrical circuit board.

10. The multi touch control type water output switching shower device as claimed in claim 1, further comprising:
a spring plate, disposed between the rechargeable batteries to connect them in series, while the rechargeable batteries are disposed on the water separating frame.
